(19) United States
(12) Patent Application Publication
(10) Pub. No.: US 2008/0065515 A1
(43) Pub. Date: Mar. 13, 2008

(54) Program management of supplier deliverables using web-enabled software

(76) Inventor: Steve B. Bowler, Hudson, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/422,297

(22) Filed: Apr. 24, 2003

Related U.S. Application Data
(60) Provisional application No. 60/375,751, filed on Apr. 26, 2002.

(51) Int. Cl. G06Q 10/00

(52) U.S. Cl. 705/28

(57) ABSTRACT

The Supplier Deliverable embodies a full integration of previously fragmented methods for managing the creation and transmission of intellectual property by a supplier that is part of a larger program. By providing the Adapters to the other applications, the Program Management Application becomes the “glue” that binds the different processes and methods together in a single place. Management and team members are better able to measure progress toward an overall product development goal, and suppliers have a single point-of-contact through which to resolve issues and report progress.

### CROSS-REFERENCE TO RELATED APPLICATION

Applicant claims priority of U.S. Provisional Patent Application in the name of Steven B. BOWLER, application No. 60/375,751, filed Apr. 26, 2002.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates to the use of Internet software to enable collaborative program management for new product development. Program management entails the scheduling of activities and their interdependencies, raising and resolving issues, managing the creation and release of critical intellectual property, building prototypes, and releasing products to full production. The overall product life cycle is managed in this manner from concept through end-of life. Metrics, problem logs, alerts, team meetings, phase exit reviews, and audits are used to keep large-scale programs on track, put them on hold, or kill them altogether in order to minimize loss. This invention fits inside the management of supplier schedule execution of deliverables. It involves using program management concepts to connect together other aspects of supplier management that occur in supply chain and bill of materials applications.

2. Description of Prior Art

In the past, management of suppliers' deliverables for complex program management involved separate schedules and teams for major suppliers. Extensive travel and ineffective communication resulted in higher cost, needless delays, and miscommunication. The most common method used by companies to deliver requirements to suppliers was to print out purchase orders, specifications, and statements of work, insert them in a mail folder, and mail them to the supplier. Upon review of this information, the supplier would mark up the documents according to their preference and procedures and mail them back to the prime contractor. This process is dramatically more complex when it is applied to the bid and proposal process, since most companies require quotes from between 3 and 8 competitors for each required part.

With the advent of more modern technologies, File Transfer Protocol (FTP) sites were set up to store files for suppliers to download. E-mail supplemented this system by adding instructions, alerting the supplier to the existence and address of the folder, and supplying due date information.

Product Data Management systems (PDMs) were then created by companies such as Parametric Technologies Corporation (PTC), Electronic Data Systems (EDS), and Dassault. These PDMs “operationalized” this process to some extent by allowing, for example, the engineering department to export files directly to the FTP site.

Approved Supplier Lists (ASLs), which were previously created and managed in spreadsheet programs such as Lotus 1-2-3 and Microsoft Excel, later were managed in software products for the supply chain such as Manugistics, Commerce One, and Ariba. Web interfaces were added to allow suppliers direct access to the drawing vault. Additional program information was still needed, however, and the prime contractor lacked an overall program view of the interdependencies and risks associated with supplier deliverables. A constant problem that resulted was the existence of bills of material in both systems that were not synchronized. Most maintenance required human intervention.

What is needed, therefore, is a centralized application that overcomes the above limitations, integrates with existing applications such as supply chain and bill of materials applications, and is web-based.

### BRIEF SUMMARY OF THE INVENTION

Using the latest Internet technology, an integrated approach can be created, whereby the Supplier Deliverable is established on the master Program plan, automatically generating a folder in PDM that is populated with the necessary documents needed for supplier execution, notifying the supplier of all the requirements for the Deliverable, and linking the supplier to the location, due date, and requirements for execution. The initial status of the Deliverable is also set at this time. As the supplier makes changes or comments, the prime contractor is alerted to those changes. An exchange of issues and action items is also initiated through this process. Changes in document status, a Deliverable's due date, or issue/action item status are also communicated automatically via integration with e-mail. For bids and proposals, requests for quote (RFQs) are automatically sent out by the system through integration with the supply chain and PDM applications.

Using program management software as the overarching application that controls communications to the other applications through integration adapters provides a single point-of-entry for all program activities, including supplier schedule control.

Objects

The Supplier Deliverable object is created as an object on the Program plan. The supplier database is maintained in the supply chain application, which links part numbers to approved supplier's contact information and lead times. The Program Management Application automatically sends the required information via an e-mail with URL to the supplier or bidder on the date determined from the required due date minus the lead-time.

Generating the Supplier Deliverable automatically creates the links to the part files in the BOM management application. Status, date, revision, and progress data is exchanged across all three applications via Adapters written in the Program Management Application.

Features

Key features of this approach are the Supplier Deliverable, integration with supply chain applications, data management applications, and e-mail clients. Using this approach, program management supplies the linkages to manage the execution of supplier bids, development, and manufacturing activities. System-generated notifications keep all involved team members apprised of status changes and issues that arise.

Advantages

There are many advantages to the invention, including the following. Other advantages will be apparent to those skilled in the art.

Instead of managing the bid and process activity in three separate software applications with a great deal of manual effort to coordinate various activities, this solution provides an automated and integrated approach that links these systems together and leverages the data in each rather than duplicating it. The resulting benefits include better schedule adherence, fewer mistakes, less rework, and more visibility into the development process across company boundaries.

### BRIEF DESCRIPTION OF THE DRAWINGS

FIG. 1 is a graphical representation of the history of the development of project management solutions for managing vendor deliverables.

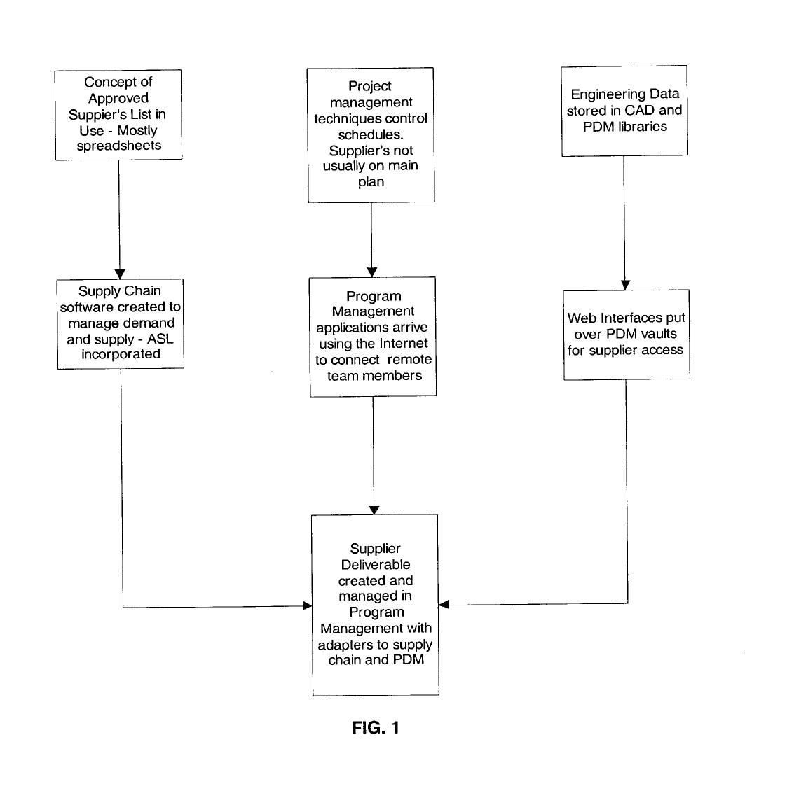

FIG. 2 shows the overall flow of the invention.

### DETAILED DESCRIPTION OF THE INVENTION, INCLUDING THE PREFERRED EMBODIMENT

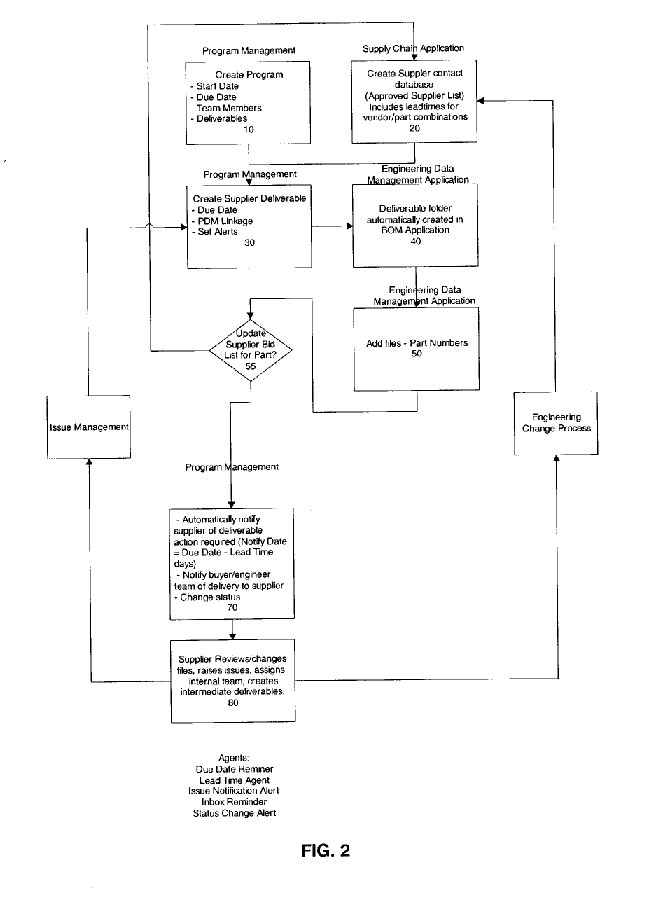

Referring now to FIG. 2.

In Step 10, a program planning function creates a Program schedule in the Program Management Application (PMA). It includes dividing the Program into Phases and Deliverables. Deliverables associated with suppliers are linked via software Adapters to supply chain and file management applications (BOM/PDM).

In Step 20, the supply chain application maintains the supplier contact information and linkages to which part numbers the supplier is qualified to supply (Approved Supplier List). The supply chain application also contains demand planning information and lead times.

In Step 30, the Supplier Deliverable is established on the master Program plan, automatically generating a folder in PDM that is populated with the necessary documents needed for supplier execution, notifying the supplier of all the requirements for the Deliverable, and linking the supplier to the location, due date, and requirements for execution. The initial status of the Deliverable is also set at this time.

In Step 40 and Step 50, The BOM/PDM application maintains the actual engineering files and the metadata associated with them such as part number, revision, parent-child relationships, and associated documents.

In Step 70, the Supplier Deliverable template includes the part numbers, drawings and lead times via integration with the other applications. When the program is activated, the supplier or bidders receive notifications with active links to the engineering data, attachments and due date information necessary to complete their assignment (Step 55). The notification is kicked off on the proper date calculated by subtracting the lead-time in the supply chain application from the due date established in the Program Management Application.

In Step 80, any issues raised by the supplier or other team members are posted in the Program Management Application and e-mailed to team members. Engineering changes are managed in the BOM/PDM application with notifications via program management. Revision status data is also sent back and forth between BOM/PDM and supply chain software.

The Program Management Application provides the “glue” that holds the entire process together via adapter sets.

1. A method of managing supplier data for a Program, said method comprising:
Creating a Supplier Deliverable, said Supplier Deliverable having Supplier Deliverable Attributes;
Providing information about said Supplier Deliverable to a Product Data Management Application;
Updating information about said Supplier Deliverable with data from said Product Data Management Application; and
Transmitting notifications about said Supplier Deliverable and said Supplier Deliverable Attributes including changes to said Supplier Deliverable and said Supplier Deliverable Attributes.

2. The method of claim 1 wherein said Transmitting is Electronic Messaging.

3. The method of claim 1 wherein said Transmitting is E-mailing.

4. The method of claim 1 further comprising:
Providing information about said Supplier Deliverable to a Supply Chain Application; and
Updating information about said Supplier Deliverable with data from said Supply Chain Application.

5. The method of claim 4 wherein said Transmitting is Electronic Messaging.

6. The method of claim 4 wherein said Transmitting is E-mailing.

7. A computerized method of managing supplier data for a Program, said method comprising:
Creating a Supplier Deliverable, said Supplier Deliverable having Supplier Deliverable Attributes;
Providing information about said Supplier Deliverable to a Supply Chain Application;
Updating information about said Supplier Deliverable with data from said Supply Chain Application;
Providing information about said Supplier Deliverable to a Product Data Management Application;
Updating information about said Supplier Deliverable with data from said Product Data Management Application; and
Transmitting notifications about said Supplier Deliverable and said Supplier Deliverable Attributes including changes to said Supplier Deliverable and said Supplier Deliverable Attributes.

8. The method of claim 7 wherein said Transmitting is Electronic Messaging.

9. The method of claim 7 wherein said Transmitting is E-mailing.

10. A computerized method of managing supplier data for a Program with a web-based Program Management Application, said method comprising:
Creating a Supplier Deliverable, said Supplier Deliverable having Supplier Deliverable Attributes, said Supplier Deliverable corresponding to one or more tables in a database, said supplier Deliverable Attributes corresponding to records and fields of said tables in said database;
Providing information about said Supplier Deliverable to a Supply Chain Application, said information including data from said fields, said records, and said tables of said database;
Updating information about said Supplier Deliverable with data from said Supply Chain Application, said information including data for said fields, said records, and said tables of said database;
Providing information about said Supplier Deliverable to a Product Data Management Application, said information including data from said fields, said records, and said tables of said database;
Updating information about said Supplier Deliverable with data from said Product Data Management Application, said information including data for said fields, said records, and said tables of said database; and
Transmitting notifications about said Supplier Deliverable and said Supplier Deliverable Attributes including changes to said Supplier Deliverable and said Supplier Deliverable Attributes.

11. The method of claim 10 wherein said Transmitting is Electronic Messaging.

12. The method of claim 10 wherein said Transmitting is E-mailing.

13. A set of Application Program Interfaces embodied on a computer-readable medium for execution on a computer in conjunction with an application program that manages supplier data, said Application Program Interfaces comprising:
A first interface that receives Deliverable Data and Deliverable Attributes Data for said Deliverable Data and updates said Deliverable Data and said Deliverable Attributes Data;
A second interface that receives Team Member Data and Team Member Attributes Data for said Team Member Data and transmits information about said Deliverable Data, said Deliverable Attributes Data, said Team Member Data and said Team Member Attributes Data.

14. A set of Application Program Interfaces embodied on a computer-readable medium for execution on a computer in conjunction with an application program that manages supplier data, said Application Program Interfaces comprising:
A first interface that receives Supplier Data and Supplier Attributes Data for said Supplier Data and updates said Supplier Data and said Supplier Attributes Data;
A second interface that receives Deliverable Data and Deliverable Attributes Data for said Deliverable Data and updates said Deliverable Data and said Deliverable Attributes Data;
A third interface that receives Team Member Data and Team Member Attributes Data for said Team Member Data and transmits information about said Supplier Data, said Supplier Attributes Data, said Deliverable Data, said Deliverable Attributes Data, said Team Member Data and said Team Member Attributes Data.

15. A system for managing supplier data for a Program, said system comprising:
A processor programmed for:
Creating a Supplier Deliverable, said Supplier Deliverable having Supplier Deliverable Attributes;
Providing information about said Supplier Deliverable to a Product Data Management Application;
Updating information about said Supplier Deliverable with data from said Product Data Management Application; and
Transmitting notifications about said Supplier Deliverable and said Supplier Deliverable Attributes including changes to said Supplier Deliverable and said Supplier Deliverable Attributes.

16. The system of claim 15 wherein said Transmitting is Electronic Messaging.

17. The system of claim 15 wherein said Transmitting is E- mailing.

18. A computer-readable medium having computer- executable instructions for a method of managing supplier data for a Program, said method comprising:
Creating a Supplier Deliverable, said Supplier Deliverable having Supplier Deliverable Attributes;
Providing information about said Supplier Deliverable to a Product Data Management Application;
Updating information about said Supplier Deliverable with data from said Product Data Management Application; and
Transmitting notifications about said Supplier Deliverable and said Supplier Deliverable Attributes including changes to said Supplier Deliverable and said Supplier Deliverable Attributes.

19. The method of claim 18 wherein said Transmitting is Electronic Messaging.

20. The method of claim 18 wherein said Transmitting is E-mailing.

21. The method of claim 1 wherein the Supplier Deliverable Attributes include a status, a delivery date, revision data, and progress data.
